(19) United States
(12) Patent Application Publication
(10) Pub. No.: US 2024/0356698 A1
(43) Pub. Date: Oct. 24, 2024

(54) DEVICES, METHODS AND COMPUTER READABLE MEDIA FOR CELLULAR COMMUNICATION

(71) Applicant: Nokia Technologies Oy, Espoo (FI)

(72) Inventors: Pasi Eino Tapio KINNUNEN, Oulu (FI); Juha Pekka KARJALAINEN, Oulu (FI); Mihai ENESCU, Espoo (FI); Sami-Jukka HAKOLA, Espoo (FI); Hiromasa UMEDA, Tokyo (JP)

(21) Appl. No.: 18/685,999

(22) PCT Filed: Aug. 29, 2022
(86) PCT No.: PCT/EP2022/073955

§ 371 Date: Feb. 23, 2024

Related U.S. Application Data
(60) Provisional application No. 63/250,447, filed on Sep. 30, 2021.

(51) Int. Cl. H04L 5/00

(52) U.S. Cl. CPC H04L 5/0048

(57) ABSTRACT

Disclosed are methods and apparatus for correspondence between downlink reference signals and uplink reference signals. A terminal device in a communication network may comprise at least one processor and at least one memory having computer program code stored thereon. The at least one memory and the computer program code may be configured, with the at least one processor, cause the terminal device to perform: transmitting, to a network device, information indicative of support of antenna port correspondence between antenna ports used for reception of downlink (DL) reference signal (RS) resources and antenna ports used for transmission of uplink (UL) reference signal resources at the terminal device: receiving, from the network device, a request for use of the antenna port correspondence at the terminal device: and transmitting, to the network device, a message indicating usage of the antenna port correspondence at the terminal device.

### TECHNICAL FIELD

Various example embodiments described herein generally relate to communication technologies, and more particularly, to devices, methods, and computer readable media for correspondence between the antenna ports used for downlink reference signals and uplink reference signals.

### BACKGROUND

In 5G New Radio (NR), a sounding reference signal (RS) may be used to estimate uplink (UL) channel quality. Transmitting the RS signal with the correct power is essential for channel sounding in the gNB. When channel reciprocity applies, for example, in a time division duplexing (TDD) system, the RS may also be used to estimate downlink (DL) channel quality. However, because there is antenna imbalance between transmission antennas in certain configuration and there are various antenna port implementations in a user equipment (UE) device, antenna ports can be different between UL and DL links. Also it is not limited how UE can assign different antenna elements to each antenna ports. Therefore, channel reciprocity cannot be assumed between DL and UL when antenna elements are configured differently in the UE devices for transmission from the uplink and reception from the downlink. This will limit the usage of UL RS measurement of different antenna ports for DL link adaptation.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, an example embodiment of a terminal device in a communication network is provided. The terminal device may comprise at least one processor and at least one memory. At least one memory includes computer program code stored thereon. At least one memory and the computer program code may be configured to, with at least one processor, cause the terminal device to perform: transmitting, to a network device, information indicative of support of antenna port correspondence between antenna ports used for reception of downlink (DL) reference signal (RS) resources and antenna ports used for transmission of uplink (UL) reference signal resources at the terminal device; receiving, from the network device, a request for use of the antenna port correspondence at the terminal device; and transmitting, to the network device, a message indicating usage of the antenna port correspondence at the terminal device.

In some embodiments, the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

In some embodiments, the antenna port correspondence indicates full correspondence in a case where the antenna ports used for reception of DL RS resources are the same antenna ports as being used for the transmission of UL RS resources at the terminal device.

In some embodiments, the antenna port correspondence indicates partial correspondence in a case where only a subset of the antenna ports used for the reception of DL RS resources are virtualized to corresponding antenna ports as being used for the transmission of UL RS resources at the terminal device.

In some embodiments, the antenna port correspondence is non-correspondence in a case where there is a fallback mode where the antenna port correspondence between DL RS and UL RS antenna ports is unknown at the terminal device.

In some embodiments, the at least one memory and the computer program code are further configured to, with the at least one processor, cause the terminal device to perform: signaling, to the network device, the antenna port correspondence semi-statically or dynamically.

In some embodiments, the at least one memory and the computer program code are further configured to, with the at least one processor, cause the terminal device to perform: determining the antenna port correspondence between UL and DL antenna ports associated with corresponding resources, before transmitting, to the network device, the antenna port correspondence.

In some embodiments, the at least one memory and the computer program code are further configured to, with the at least one processor, cause the terminal device to perform transitioning in the fallback mode in a case where there is non-correspondence between the antenna ports used for the reception of DL RS resources and the antenna ports used for the transmission of UL RS resources at the terminal device.

In some embodiments, the at least one memory and the computer program code are further configured to, with the at least one processor, cause the terminal device to perform continuing with maintenance of the antenna port correspondence for the next K slots in a case where there is the same level of correspondence between the antenna ports used for the reception of DL RS resources and the antenna ports used for the transmission of UL RS resources at the terminal device and the value of K is used as a timer indicative of validity of the antenna port correspondence.

In some embodiments, the at least one memory and the computer program code are further configured to, with the at least one processor, cause the terminal device to perform: sending, to the network device, a DL RS and UL RS antenna port virtualization suspend message in a case where the terminal device determines that the antenna port correspondence between the DL RS and UL RS is suspended at the terminal device.

In some embodiments, the at least one memory and the computer program code are further configured to, with the at least one processor, cause the terminal device to perform transitioning in the fallback mode in a case where the terminal device determines that the antenna correspondence is suspended at the terminal device.

In some embodiments, the downlink reference signal includes a demodulation reference signal, (DMRS) for data/control, or phase tracking reference signal (PTRS), or non-zero power channel state information reference signal (NZP-CSI-RS) for channel information acquisition or NZP-CSI-RS for frequency and time tracking or NZP-CSI-RS for beam management (BM).

In some embodiments, the uplink reference signal includes a sounding reference signal (SRS) or demodulation reference signal (DMRS) for data/control or phase tracking reference signal (PTRS) or preamble of physical random access channel (PRACH).

In some embodiments, the at least one memory and the computer program code are further configured to, with the at least one processor, cause the network device to perform: transmitting, to the network device, information on which associated antenna ports are selected by considering the antenna port correspondence or without considering the antenna port correspondence having correspondence and/or which antenna ports are having non-correspondence.

In some embodiments, the at least one memory and the computer program code are further configured to, with the at least one processor, cause the network device to perform: transmitting, to the network device an indication of power imbalance on the associated antenna ports selected between by considering the antenna port correspondence or without considering the antenna port correspondence at the terminal device.

In some embodiments, a metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

In some embodiments, the at least one memory and the computer program code are further configured to, with the at least one processor, cause the terminal device to perform: sending, to the network device, a DL RS and UL RS antenna port virtualization suspend message in a case where the terminal device detects that a current antenna port correspondence state is not maintainable.

In some embodiments, the maintainable current antenna port correspondence state indicates unexpected change in signal quality or due transmit transmission regulations.

In some embodiments, the fallback mode comprises a default antenna transmission mode where UL RS is virtualized into primary antenna port.

In some embodiments, the at least one memory and the computer program code are further configured to, with the at least one processor, cause the terminal device to switch into the fallback mode in a case where the terminal device receives, from the network device, a Layer1 or Layer2 control message to suspend the antenna port correspondence information.

In a second aspect, an example embodiment of a network device in a communication network is provided. The network device may comprise at least one processor and at least one memory.

At least one memory includes computer program code stored thereon. At least one memory and the computer program code may be configured to, with at least one processor, cause the network device to perform: receiving, from a terminal device, information indicative of support of antenna port correspondence between the antenna ports used for reception of downlink (DL) reference signal (RS) resources and antenna ports used for transmission of uplink (UL) reference signal resources at the terminal device; transmitting, to the terminal device, a request for use of the antenna port correspondence at the terminal device; and receiving, from the terminal device, a message indicating usage of the antenna port correspondence information at the terminal device.

In some embodiments, the antenna port correspondence indicates full correspondence in a case where the antenna ports used for reception of DL RS resources are the same antenna ports as being used for the transmission of UL RS resources at the terminal device.

In some embodiments, the antenna port correspondence information indicates partial correspondence in a case where only a subset of the antenna ports used for the reception of DL RS resources are virtualized to corresponding antenna ports as being used for the transmission of UL RS resources at the terminal device.

In some embodiments, the antenna port correspondence is non-correspondence in a case where there is a fallback mode where the antenna port correspondence between DL RS and UL RS ports is unknown at the terminal device.

In some embodiments, the at least one memory and the computer program code are further configured to, with the at least one processor, cause the network device to perform transitioning in the fallback mode in a case where there is non-correspondence between the antenna ports used for the reception of DL RS resources and the antenna ports used for the transmission of UL RS resources at the terminal device.

In some embodiments, the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

In some embodiments, the a−t least one memory and the computer program code are further configured to, with the at least one processor, cause the network device to continue with maintenance of the antenna port correspondence and/or update the antenna port correspondence in a DL control message to the terminal device.

In some embodiments, the at least one memory and the computer program code are further configured to, with the at least one processor, cause the network device to perform transmitting, to the terminal device, a request for information on which antenna ports are having correspondence and/or which antenna ports are having non-correspondence.

In some embodiments, the at least one memory and the computer program code are further configured to, with the at least one processor, cause the network device to perform: transmitting, to the terminal device, a request for indication of power imbalance between correspondence and non-correspondence antenna ports at the terminal device.

In some embodiments, a metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

In some embodiments, the at least one memory and the computer program code are further configured to, with the at least one processor, cause the network device to perform continuing maintenance of the antenna port correspondence for the next K slot in a case where there is the same level of correspondence between antenna ports used for the reception of DL RS resources and antenna ports used for the transmission of UL RS resources at the terminal device, wherein the value of K is used as a timer to indicate validity of the antenna port correspondence.

In some embodiments, the at least one memory and the computer program code are further configured to, with the at least one processor, cause the network device to perform transitioning in the fallback mode in a case where the network device receives a DL RS and UL RS antenna port virtualization suspend message from the terminal device.

In some embodiments, the at least one memory and the computer program code are further configured to, with the at least one processor, cause the network device to perform transitioning in the fallback mode in a case where the network device detects that the antenna port correspondence between the DL RS and UL RS is suspended at the terminal device.

In some embodiments, the network device detects that the antenna port correspondence between the DL RS and UL RS is suspended in any of the following cases: the network receiving, from the terminal device, messages indicating non-correspondence between DL RS and UL RS antenna ports; the antenna port correspondence between the DL RS and UL RS being suspended by configuring DTX period; the antenna port correspondence between the DL RS and UL RS being suspended by configuring transmission mode in slot where DL&UL correspondence is not defined; and the antenna port correspondence between the DL RS and UL RS being suspended from reception measurements of discontinuity of UL&DL correspondence.

In a third aspect, an example embodiment of a method implemented at a terminal device in a communication network is provided. The method may comprise: transmitting, to a network device, information indicative of support of antenna port correspondence between antenna ports used for reception of downlink (DL) reference signal (RS) resources and antenna ports used for transmission of uplink (UL) reference signal resources at the terminal device; receiving, from the network device, a request for use of the antenna port correspondence at the terminal device; and transmitting, to the network device, a message indicating usage of the antenna port correspondence at the terminal device.

In some embodiments, the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

In some embodiments, the antenna port correspondence indicates full correspondence in a case where the antenna ports used for reception of DL RS resources are the same antenna ports as being used for the transmission of UL RS resources at the terminal device.

In some embodiments, the antenna port correspondence indicates partial correspondence in a case where only a subset of the antenna ports used for the reception of DL RS resources are virtualized to corresponding antenna ports as being used for the transmission of UL RS resources at the terminal device.

In some embodiments, the antenna port correspondence is non-correspondence in a case where there is a fallback mode where the antenna port correspondence between DL RS and UL RS antenna ports is unknown at the terminal device.

In some embodiments, the method further comprises: signaling, to the network device, the antenna port correspondence semi-statically or dynamically.

In some embodiments, further comprises: determining the antenna port correspondence between UL and DL antenna ports associated with corresponding resources, before transmitting, to the network device, the antenna port correspondence.

In some embodiments, further comprises: transitioning in the fallback mode in a case where there is non-correspondence between the antenna ports used for the reception of DL RS resources and the antenna ports used for the transmission of UL RS resources at the terminal device.

In some embodiments, the method further comprises: continuing with maintenance of the antenna port correspondence for the next K slots in a case where there is the same level of correspondence between the antenna ports used for the reception of DL RS resources and the antenna ports used for the transmission of UL RS resources at the terminal device and the value of K is used as a timer indicative of validity of the antenna port correspondence.

In some embodiments, the method further comprises: sending, to the network device, a DL RS and UL RS antenna port virtualization suspend message in a case where the terminal device determines that the antenna port correspondence between the DL RS and UL RS is suspended at the terminal device.

In some embodiments, the method comprises: transitioning in the fallback mode in a case where the terminal device determines that the DL RS and UL RS antenna correspondence is suspended.

In some embodiments, the downlink reference signal includes a demodulation reference signal, (DMRS) for data/control, or phase tracking reference signal (PTRS), or non-zero power channel state information reference signal (NZP-CSI-RS) for channel information acquisition or NZP-CSI-RS for frequency and time tracking or NZP-CSI-RS for beam management (BM).

In some embodiments, the uplink reference signal includes a sounding reference signal (SRS) or demodulation reference signal (DMRS) for data/control or phase tracking reference signal (PTRS) or preamble of physical random access channel (PRACH).

In some embodiments, the method further comprises: transmitting, to the network device, information on which antenna ports are having correspondence and/or which antenna ports are having non-correspondence.

In some embodiments, the method further comprises: transmitting, to the network device an indication of power imbalance on the associated antenna ports selected by considering the antenna port correspondence or without considering the antenna port correspondence at the terminal device.

In some embodiments, a metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

In some embodiments, the method further comprises: sending, to the network device, a DL RS and UL RS antenna port virtualization suspend message in a case where the terminal device detects that a current antenna port correspondence state is not maintainable.

In some embodiments, the maintainable current antenna port correspondence state indicates unexpected change in signal quality or due transmit transmission regulations.

In some embodiments, the fallback mode comprises a default antenna transmission mode where UL RS is virtualized into primary antenna port.

In some embodiments, further comprises: switching into the fallback mode in a case where the terminal device receives, from the network device, a Layer1 or Layer2 control message to suspend the antenna port correspondence information.

In a fourth aspect, an example embodiment of a method implemented at a network device in a communication network is provided. The method may comprise receiving, from a terminal device, information indicative of support of antenna port correspondence between the antenna ports used for reception of downlink (DL) reference signal (RS) resources and antenna ports used for transmission of uplink (UL) reference signal resources at the terminal device; transmitting, to the terminal device, a request for use of the antenna port correspondence at the terminal device; and receiving, from the terminal device, a message indicating usage of the antenna port correspondence information at the terminal device.

In some embodiments, the antenna port correspondence indicates full correspondence in a case where the antenna ports used for reception of DL RS resources are the same antenna ports as being used for the transmission of UL RS resources at the terminal device.

In some embodiments, the antenna port correspondence indicates partial correspondence in a case where only a subset of the antenna ports used for the reception of DL RS resources are virtualized to corresponding antenna ports as being used for the transmission of UL RS resources at the terminal device.

In some embodiments, the antenna port correspondence is non-correspondence in a case where there is a fallback mode where the antenna port correspondence between DL RS and UL RS antenna ports is unknown at the terminal device.

In some embodiments, further comprises: transitioning in a fallback mode in a case where there is non-correspondence between antenna ports used for the reception of DL RS resources and antenna ports used for the transmission of UL RS resources at the terminal device.

In some embodiments, the antenna port correspondence is non-correspondence in a case where there is a fallback mode where the antenna port correspondence between DL RS and UL RS ports is unknown at the terminal device.

In some embodiments, further comprises: transitioning in the fallback mode in a case where there is non-correspondence between the antenna ports used for the reception of DL RS resources and the antenna ports used for the transmission of UL RS resources at the terminal device.

In some embodiments, the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

In some embodiments, further comprises transmitting, to the terminal device, a request for information on which antenna ports are having correspondence and/or which antenna ports are having non-correspondence.

In some embodiments, further comprising: transmitting, to the terminal device, a request for indication of imbalance between correspondence and non-correspondence antenna ports at the terminal device.

In some embodiments, a metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

In some embodiments, the method further comprises: continuing with maintenance of the antenna port correspondence for the next K slots in a case where there is the same level of correspondence between the antenna ports used for the reception of DL RS resources and the antenna ports used for the transmission of UL RS resources at the terminal device and the value of K is used as a timer indicative of validity of the antenna port correspondence.

In some embodiments, the method further comprises: transitioning in the fallback mode in a case where the network device receives a DL RS and UL RS antenna port virtualization suspend message from the terminal device.

In some embodiments, the method further comprises: transitioning in the fallback mode in a case where the network device detects that the antenna port correspondence between the DL RS and UL RS is suspended at the terminal device.

In some embodiments, the network device detects that the antenna port correspondence information between the DL RS and UL RS is suspended in any of the following cases: the network receiving, from the terminal device, messages indicating non-correspondence between DL RS and UL RS antenna ports; the antenna port correspondence information between the DL RS and UL RS being suspended by configuring DTX period; the antenna port correspondence information between the DL RS and UL RS being suspended by configuring transmission mode in slot where DL&UL correspondence is not defined; and the antenna port correspondence information between the DL RS and UL RS being suspended from reception measurements of discontinuity of UL&DL correspondence.

In a fifth aspect, an example embodiment of an apparatus in a communication network is provided. Apparatus may comprise means for transmitting, to a network device, information indicative of support of antenna port correspondence between antenna ports used for reception of downlink (DL) reference signal (RS) resources and antenna ports used for transmission of uplink (UL) reference signal resources at the terminal device; means for receiving, from the network device, a request for use of the antenna port correspondence at the terminal device and means for transmitting, to the network device, a message indicating usage of the antenna port correspondence at the terminal device.

In a sixth aspect, an example embodiment of an apparatus in a communication network is provided. Apparatus may comprise means for receiving, from a terminal device, information indicative of support of antenna port correspondence between the antenna ports used for reception of downlink (DL) reference signal (RS) resources and antenna ports used for transmission of uplink (UL) reference signal resources at the terminal device; means for transmitting, to the terminal device, a request for use of the antenna port correspondence at the terminal device; and means for receiving, from the terminal device, a message indicating usage of the antenna port correspondence information at the terminal device.

In a seventh aspect, an example embodiment of a computer program is provided. The computer program may comprise instructions stored on a computer readable medium. The instructions may, when executed by at least one processor of a terminal device in a communication network, cause the terminal device to perform: transmitting, to a network device, information indicative of support of antenna port correspondence between antenna ports used for reception of downlink (DL) reference signal (RS) resources and antenna ports used for transmission of uplink (UL) reference signal resources at the terminal device; receiving, from the network device, a request for use of the antenna port correspondence at the terminal device; and transmitting, to the network device, a message indicating usage of the antenna port correspondence at the terminal device.

In an eighth aspect, an example embodiment of a computer program is provided. The computer program may comprise instructions stored on a computer readable medium. The instructions may, when executed by at least one processor of a network device in a communication network, cause the network device to perform: receiving, from a terminal device, information indicative of support of antenna port correspondence between the antenna ports used for reception of downlink (DL) reference signal (RS) resources and antenna ports used for transmission of uplink (UL) reference signal resources at the terminal device; transmitting, to the terminal device, a request for use of the antenna port correspondence at the terminal device; and receiving, from the terminal device, a message indicating usage of the antenna port correspondence information at the terminal device.

Other features and advantages of the example embodiments of the present disclosure will also be apparent from the following description of specific embodiments when read in conjunction with accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to accompanying drawings.

FIG. 1 is a schematic diagram illustrating a communication system in which example embodiments of the present application can be implemented.

FIG. 2 shows an exemplary sequence diagram for correspondence between downlink reference signal and uplink reference signal according to an embodiment of the present disclosure.

FIG. 3 shows a flow chart illustrating an example method 300 for an exemplary scenario, according to an example embodiment of the present disclosure.

FIG. 4 shows a block diagram illustrating an example communication network 400 for correspondence between downlink reference signal and uplink reference signal according to an embodiment of the present disclosure.

FIG. 5 shows a flow chart illustrating an example method 500 for correspondence between downlink reference signal and uplink reference signal according to an embodiment of the present disclosure.

FIG. 6 shows a flow chart illustrating an example method 600 for correspondence between downlink reference signal and uplink reference signal according to an embodiment of the present disclosure.

FIG. 7 shows a block diagram illustrating an example apparatus 700 for correspondence between downlink reference signal and uplink reference according to an embodiment of the present disclosure.

FIG. 8 shows a block diagram illustrating an example apparatus 800 for correspondence between downlink reference signal and uplink reference according to an embodiment of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to accompanying drawings. The following description includes specific details for the purpose of providing a thorough understanding of various concepts. However, it will be apparent to those skilled in art that these concepts may be practiced without these specific details. In some instances, well known circuits, techniques and components are shown in block diagram form to avoid obscuring the described concepts and features.

As used herein, the term “network device” refers to any suitable entities or devices that can provide cells or coverage, through which the terminal device can access the network or receive services. The network device may be commonly referred to as a base station. The term “base station” used herein can represent a node B (NodeB or NB), an evolved node B (eNodeB or eNB), or a gNB or an ng-eNB. The base station may be embodied as a macro base station, a relay node, or a low power node such as a pico base station or a femto base station. The base station may consist of several distributed network units, such as a central unit (CU), one or more distributed units (DUs), one or more remote radio heads (RRHs) or remote radio units (RRUs). The number and functions of these distributed units depend on the selected split RAN architecture.

As used herein, the term “terminal device” or “user equipment” (UE) refers to any entities or devices that can wirelessly communicate with the network devices or with each other. Examples of the terminal device can include a mobile phone, a mobile terminal, a mobile station, a subscriber station, a portable subscriber station, an access terminal, a computer, a wearable device, an on-vehicle communication device, a machine type communication (MTC) device, an internet of things (IOT) device, an internet of everything (IoE) device, a device-to-device (D2D) communication device, a vehicle to everything (V2X) communication device, a sensor and the like. The term “terminal device” can be used interchangeably with UE, a user terminal, a mobile terminal, a mobile station, or a wireless device.

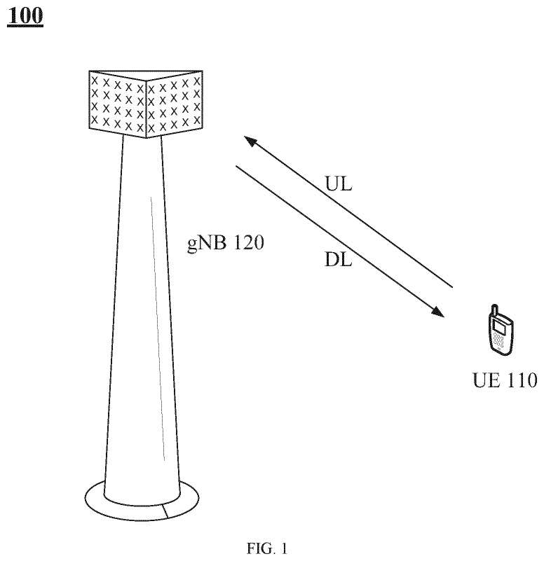

FIG. 1 illustrates a schematic diagram of a communication system 100 in which example embodiments of the present disclosure can be implemented. Referring to FIG. 1, the communication system 100 may include user equipment (UE) device 110 and a base station 120 shown as gNB. The UE device 110 may communicate with the gNB 120 on uplink (UL) and downlink (DL) channels. The UE device 110 and the base station 120 may be a part of a cellular communication network, such as a 5G NR network, in which the UE device 110 may be implemented as an NR-enabled UE device 110, and the base station 120 may be implemented as a next Generation Node-B (gNB). It would be appreciated that the NR network may comprise more than one UE devices 110 and/or more than one gNB 120. The UE device 110 may camp on a cell served by the gNB 120 and wirelessly communicate with the gNB 120 on uplink (UL) and downlink (DL) channels. Although not shown, the gNB 120 may also connect to other base stations via wireless or wired connections. The gNB 120 provides access to the network for the UE device 110.

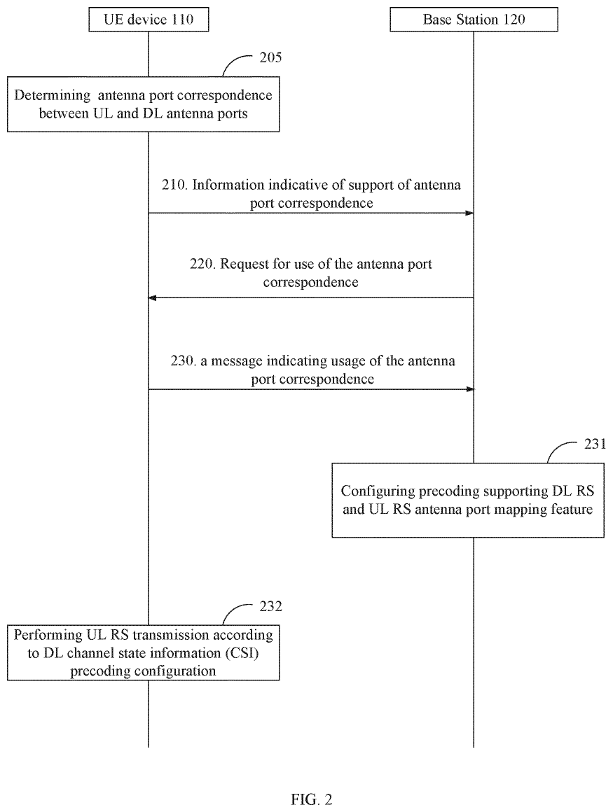

FIG. 2 shows an exemplary sequence diagram for correspondence between downlink reference signal and uplink reference signal according to an embodiment of the present disclosure. Referring to the FIG. 2, the UE device 110 may be a terminal device having multiple antenna ports associated with different communication channels, and channel quality for one antenna port may be different from channel quality for another antenna port. The UE device 110 may be configured to transmit reference signals (RSs), such as sounding reference signals (SRS), on RS resources to the base station 120, and the number of the RSs and/or the RS resources may be determined based on the number of antenna ports. The base station 120 may be a device on the network side. The base station 120 may be configured to receive reference signals (RSs), such as sounding reference signals (SRS), on RS resources from the UE device 110, and the base station 120 may measure the channel quality based on the received RSs. The UE device 110 is associated with a cell the base station 120 covers.

In an operation 210, the UE device 110 may be configured to transmit to the base station 120, information indicative of support of antenna port correspondence between antenna ports used for reception of downlink (DL) reference signal (RS) resources and antenna ports used for transmission of uplink (UL) reference signal resources at the terminal device. The base station 120, on the other hand, can receiving from the UE device 110 the information indicative of support of antenna port correspondence between the antenna ports used for the reception of the downlink (DL) reference signal (RS) resources and antenna ports used for the transmission of uplink (UL) reference signal resources at the terminal device.

In one embodiment, the downlink reference signal can be a demodulation reference signal (DMRS) for data/control, or phase tracking reference signal (PTRS), or non-zero power channel state information reference signal (NZP-CSI-RS) for channel information acquisition or NZP-CSI-RS for frequency and time tracking or NZP-CSI-RS for beam management (BM).

In another embodiment, the uplink reference signal can be a sounding reference signal (SRS) (SRS) or demodulation reference signal (DMRS) for data/control or phase tracking reference signal (PTRS) or preamble of physical random access channel (PRACH).

In one embodiment, antenna port correspondence indicates full correspondence in a case where the antenna ports used for reception of DL RS resources are the same antenna ports as used for transmission of UL RS resources at the terminal device. The antenna port correspondence indicates partial correspondence in a case where certain subset of antenna ports used for the reception of DL RS resources are virtualized to corresponding antenna ports as used for transmission of UL RS resources at the terminal device. The information indicative of support of antenna port correspondence indicates non-correspondence when it is a fallback mode where antenna port correspondence information between DL RS and UL RS ports is unknown.

In one embodiment, when the antenna port correspondence indicates partial correspondence, the base station 120 may transmit to the UE device 110 a request for information on which antenna ports are having correspondence and/or which antenna ports are having non-correspondence. Then, per the request, the UE device 110 can transmit to the base station 120 information on which antenna ports are having correspondence and/or which antenna ports are having non-correspondence.

In another embodiment, when the antenna port correspondence indicates partial correspondence, the base station 120 may transmit to the UE device 110 a request for indication of imbalance between correspondence and non-correspondence antenna ports at the terminal device. And then, per the request, the UE device 110 can also transmit to the base station 120 an indication of imbalance between correspondence and non-correspondence antenna ports at the terminal device. The UE total transmit (TX) power is distributed over TX antenna ports. In normal operation power is equally distributed between antenna ports. Here, imbalance means that antenna ports are not sharing same power level and could be intended due related power control or due implementation of power amplifier (PA) unit. Typically, this also means that imbalance antennas, i.e. non-correspondence antenna ports, may share different phases of the RS in addition to power offset when compare to other antenna ports.

In one embodiment, the metric for the indication of imbalance can be based on signal to interference plus noise ratio (SINR), reference signal received power (RSRP), reference signal received quality (RSRQ), received signal strength indicator (RSSI) of RS measurement from any of antenna port and indication of imbalance is triggered when the measurement exceeds given threshold. Also the imbalance may be caused by implementation loss, i.e. power offset, between antenna ports.

In one embodiment, transmission of the information indicative of support of antenna port correspondence can be semi-statically configured with RRC level. It can also be dynamically updated by using Layer 1 or Layer 2 (MAC) level reporting on PUCCH or PUSCH using at least1 bit in a UL control message.

In one embodiment, before the UE device 120 transmits, at 210, to the network device information indicative of support of antenna port correspondence between the antenna ports used for the reception of the downlink (DL) reference signal and antenna ports used for transmission of uplink (UL) reference signal at the terminal device when antenna port virtualization feature is enabled, the UE device can determine, at 205, the antenna port correspondence between UL and DL antenna ports associated with corresponding resources.

In an operation 220, the base station 120 may transmit to the UE device a request for use of the antenna port correspondence at the UE device 110. On the other hand, the UE device 110 may receive from the base station 120 the request for use of the antenna port correspondence at the UE device 110.

In one embodiment, the base station 120 may send Layer 1 or Layer 2 message of triggering DL DMRS&SRS antenna port virtualization message on in case of activating feature for UE or off in case of deactivating feature for UE. The message could be included with antenna port configuration and is length of at least one bit. For example, two bits gives more options for the UE device 110 to use: full, partial and no correspondence; one remaining state can be optional. In another embodiment, the UE device can simply detect DL control of DMRS&SRS antenna port message and trigger DL DMRS&SRS antenna port virtualization feature on or off based on message for given antenna configuration.

In an operation 230, per the request from the base station 120, the UE device 110 may transmit to the base station 120 a message indicating usage of the antenna port correspondence at the terminal device, and the base station 120 can receiving from the UE device 110 the message indicating usage of antenna port correspondence.

In one embodiment, the request may comprise information on when to use the related DL RS and UL RS antenna port(s) correspondence at the UE device 110. In another embodiment, the network device may directly transmit the DL RS and UL RS antenna port correspondence information request if the network device has already received the information indicative of support of antenna port correspondence beforehand. For example, if connection has been setup earlier with the information indicative of support of antenna port correspondence at operation 210, and the UE device 110 is ended up into the fallback mode. Then the information indicative of support of antenna port correspondence at operation 210 can be assumed in some embodiments as already known by the base station 120. Then the signaling of the information indicative of support of antenna port correspondence at operation 210 can be omitted and the base station 120 can proceed directly into signaling a request for use of the antenna port correspondence at operation 220.

In one embodiment, the UE device 110 can signal, to the BS 120, the antenna port correspondence semi-statically or dynamically. The transmission of the antenna port correspondence can be semi-statically configured with RRC level. It can also be dynamically updated by using Layer 1 (PHY) or Layer 2 (MAC) level reporting on PUCCH or PUSCH using at least1 bit in a UL control message.

In one embodiment, if the antenna port correspondence indicates that the correspondence between the DL RS antenna ports and the UL RS antenna ports, i.e. DL DMRS and UL SRS antenna port virtualization feature is currently in use, then the base station 120 may configure precoding supporting DL RS and UL RS antenna port virtualization feature using UL SRS measurement.

In another embodiment, if the antenna port correspondence indicates that DL RS and UL SRS antenna port virtualization feature at the UE device 110 is currently in use, and the base station 120 configured precoding supporting DL RS and UL RS antenna port virtualization feature, then, at 232, the UE device 110 can perform UL RS transmission according to DL channel state information (CSI) precoding configuration.

On the other hand, in another embodiment, if the antenna port correspondence indicates that there is non-correspondence between antenna ports used for the reception of DL RS resources and antenna ports used for the transmission of UL RS resources at the terminal device, the UE device 110 may work in a fallback mode. In this case, the base station 120 may also work in the fallback mode.

In one embodiment, if the antenna port correspondence indicates that the correspondence between the DL RS antenna ports and the UL RS antenna ports, i.e. DL RS and UL RS antenna port virtualizationfeature is currently in use, then both the UE device 110 and the base station 110 can continue with t maintenance of DL RS and UL RS antenna port correspondence for the next K slots, as long as there is the same level of correspondence between antenna ports used for the reception of DL RS resources and antenna ports used for the transmission of UL RS resources at the terminal device. The value of K may work as a timer to indicate the validity of antenna port correspondence. For example, the value of K may be configured by the network and it may depend on the antenna port correspondence capability of the UE device 110.

At the same time, in one embodiment, the base station 120 can also continue with the DL DMRS and UL SRS antenna port correspondence maintenance and update the DL DMRS and UL SRS antenna port correspondence information in DL control message.

Furthermore, in one embodiment, if the UE device determines that antenna port virtualization feature indicated in the antenna port correspondence is suspended, the UE device 110 can switch into a fallback mode and it can also send to the base station 120 a DL RS and UL RS antenna port virtualization suspend message. On receiving the DL RS and UL RS antenna port virtualization suspend message from the UE device 110, the base station 110 can also switch into the fallback mode.

In another embodiment, if the UE device detects that the antenna port correspondence between the DL RS and UL RS can't continue, the UE device 110 can also switch into a fallback mode and send to the base station 120 a DL RS and UL RS antenna port virtualizationsuspend message. On receiving the DL RS and UL RS antenna port virtualizationsuspend message from the UE device 110, the base station 110 can also switch into the fallback mode.

In one embodiment, the UE device 110 can detect that it cannot maintain current antenna port correspondence state from DL measurements indicating unexpected change in signal quality. For example, there may be signal power change of certain threshold in hand over scenario, or limitations due RAN4 requirements and the like. The UE device 110 can also detect that it cannot maintain current antenna port correspondence state from due transmit transmission regulations. For example, UE sensors detect human body near transmit antenna elements.

On the other hand, in one embodiment, the base station 120 can perform in the fallback mode when the base station 120 detects that the antenna port correspondence between the DL RS and UL RS is suspended. Specifically, the base station 120 detects that the antenna port correspondence between the DL RS and UL RS is suspended in any of the following cases: the network receiving, from the terminal device, messages indicating non-correspondence between DL RS and UL RS antenna ports; the antenna port correspondence between the DL RS and UL RS being suspended by configuring DTX period; the antenna port correspondence between the DL RS and UL RS being suspended by configuring transmission mode in slot where DL&UL correspondence is not defined; and the antenna port correspondence between the DL RS and UL RS being suspended from reception measurements of discontinuity of UL&DL correspondence.

In another embodiment, after the UE device 110 and the base station 120 switch into the fallback mode, the UE antenna ports can use default antenna transmission mode, such as ingle antenna port, antenna switching mode, where UL RS is virtualized into primary antenna port. It is assumed that UE receives DL RS with same antenna ports. Or the UE antenna ports can also use one antenna port at a time for UL transmission and indicate power offset against primary antenna port.

In one embodiment, each TX antenna configuration can be configured in similar approach as shown in above flow diagram. Different band combination could be used for DL related setup, such as the connection of DL and UL for each band combination. When the UE device 110 has informed that it will use same receive antennas as for SRS then we can rely on that despite of channel combination. For the fallback mode, the simplest common fallback schema is a single antenna transmission in all cases which provides good robustness to channel discontinuity. However, if network requires, it can define different transmission modes as fall back modes for SRS, such as 2TX antenna setup etc. Currently 1/2/4 APs are defined for UL, so the best candidates would be these 1 and 2 in aperiodic/semi-persistent/per iodic mode allocated for the next slots. Subset of other possible antenna port can be seen as partial antenna port virtualization scheme like DL 4AP to UL 3AP or DL 8AP to UL 6AP. UL and DL correspondence antenna port virtualization would be with over DL ‘X’ AP to UL ‘X’ AP, where X is at least 1 antenna port.

Power control would not be impacted when switching into fall back mode. Power Amplifier would use same total power at transmit ports as earlier. If needed, the base station 120 may configure additional power offset when switching from DMRS&SRS mode to fallback mode. Due to mobility, UE rotation, path loss change in dynamic environment, UE may also change dynamically DL DMRS&SRS antenna port correspondence mode.

In other embodiment power balancing between antenna ports is done in such a way that coherent antenna ports are coherent over antenna ports from power usage point of view between UL and DL, that is, no power imbalance between UL and DL coherent antenna ports. Additional non-coherent antenna ports can be used for power imbalance control between coherent and non-coherent antenna ports. The UE device 110 can signal these non-coherent antenna ports in uplink control signal. By this way, the base station 120 can detect non coherent antenna ports of the UE device in case of partial coherent antenna ports and use that information for link adaptation control.

According to the present disclosure, because of the correspondence between the antenna ports used for the reception of the downlink (DL) reference signal (RS) resources and antenna ports used for the transmission of uplink (UL) reference signal resources at the terminal device, channel reciprocity may be assumed between DL and UL when antenna elements are configured differently in the UE device for transmission (UL) and reception (DL). This will facilitate usage of UL RS measurement of different antenna ports for DL link adaptation.

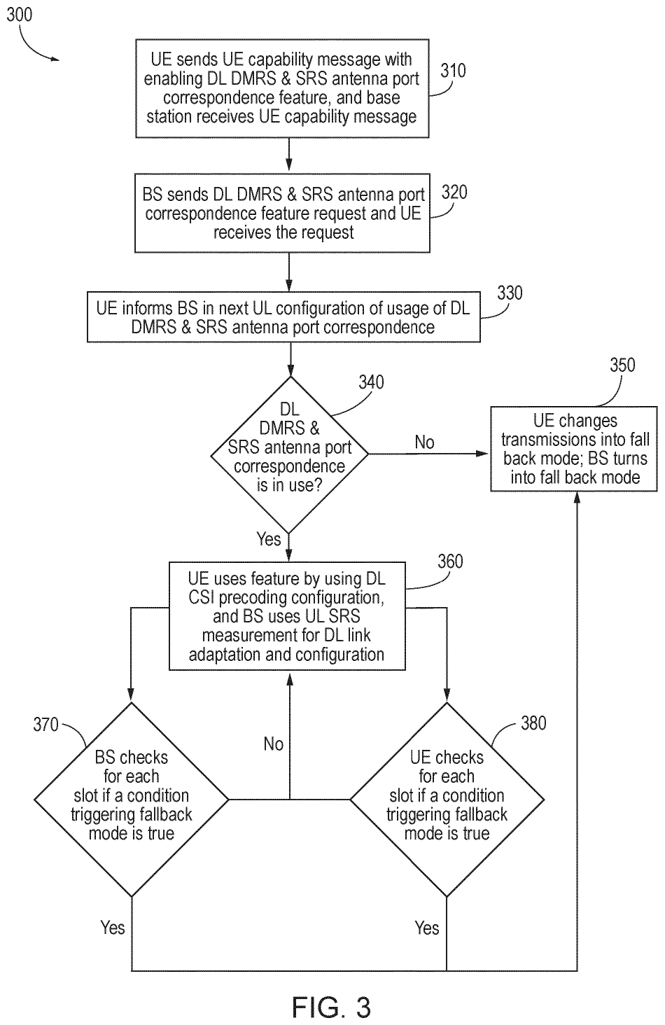

For example, FIG. 3 shows a flow chart illustrating an example method 300 for an exemplary scenario, where the correspondence between antenna ports used for the reception of downlink reference signal and antenna ports used for the transmission uplink reference signal would be enabled according to an example embodiment of the present disclosure.

At step 310, the UE device 110 can send UE capability message with enabling DL DMRS & SRS antenna port correspondence feature, and base station can receive the UE capability message when DL DMRS & SRS antenna port correspondence is enabled.

At step 320, the base station (BS) 120 may send a DL DMRS & SRS antenna port correspondence feature request to the UE device, and the UE device 110 can receive the request. It could be a dynamic or semi-static request, as discussed above. Details of which have been described in the above descriptions, and repetitive descriptions thereof are omitted here.

Then at step 330, the UE device 110 may inform the BS 120 in the next UL configuration of usage of DL DMRS & SRS antenna port correspondence usage in the antenna port correspondence. Details of which have been described in the above descriptions, and repetitive descriptions thereof are omitted here.

Then at step 340, it is determined whether DL DMRS & SRS antenna port correspondence is in use at the UE device 120. If DL DMRS & SRS antenna port correspondence is not in use, then at step 350, the UE device 110 changes transmissions into fall back mode; and the BS 120 also turns into fall back mode.

On the other hand, if it is determined, at step 340, that DL DMRS & SRS antenna port correspondence is in use at the UE device 120, then at step 360, UE may use this correspondence feature by using DL CSI precoding configuration, and BS may use UL SRS measurement for DL link adaptation and configuration. Details of which have been described in the above descriptions, and repetitive descriptions thereof are omitted here.

Meanwhile, while the UL&DL antenna port correspondence state continues, at step 370, the BS 120 may check for each slot whether any of the following conditions triggering the fallback mode is true: whether the BS 120 receives UE message indicating non-correspondence of DL&UL antenna ports; whether the BS 120 detects from receive SRS measurements (e.g. RSRP) of discontinuity of UL&DL correspondence; whether the BS 120 configuring transmission mode in the slot where DL&UL correspondence is not defined; or whether the BS 120 configured DTX period. If none of the aforementioned cases is true, then the UL&DL antenna port correspondence state continues. If any of the cases is true, the BS 120 may change into fall back mode and inform the UE device 110; and the UE device 110 may also turn into fall back mode on receiving the informing from the BS 120.

At the same time, at step 380, the UE device 110 may also check for each slot whether any of the following conditions triggering the fallback mode is true: whether the UE device 110 detects that it cannot maintain current antenna port correspondence state; whether the UE device 110 receives L1 or L2 control message to discontinuity of correspondence state; whether the UE device 110 shall maintain correspondence over K-slots (K>=1); whether the DL measurements indicating unexpected change in signal quality; or whether there is discontinuity due TX transmission regulations (e.g. UE sensors detecting human body near TX antenna elements). If none of the aforementioned cases is true, then the UL&DL antenna port correspondence state continues. If any of the cases is true, the UE device 110 may change into fall back mode and inform the BS 120; and the BS 120 may also turn into fall back mode upon receiving the informing from the UE device 110.

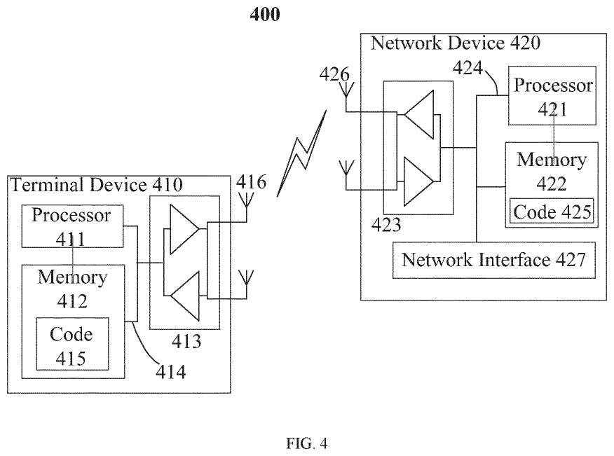

FIG. 4 is a block diagram illustrating a communication network 600 in which example embodiments of the present disclosure can be implemented. The communication network 600 may be a part of a larger communication network or system. As shown in FIG. 4, the communication network 400 may include a terminal device 410 which may be implemented as the UE device 110 discussed above, and a network device 420 which may be implemented as the base station (gNB) 120 discussed above.

Referring to FIG. 4, the terminal device 410 may comprise one or more processors 411, one or more memories 412 and one or more transceivers 413 interconnected through one or more buses 414. The one or more buses 414 may be address, data, or control buses, and may include any interconnection mechanism such as series of lines on a motherboard or integrated circuit, copper cables, optical fibers, or other electrical/optical communication equipment, and the like. Each of the one or more transceivers 413 may comprise a receiver and a transmitter, which are connected to a plurality of antennas 416. The plurality of antennas 416 may form an antenna array to perform beamforming communication with the network device 420. The one or more memories 412 may include computer program code 415. The one or more memories 412 and the computer program code 415 may be configured to, when executed by the one or more processors 411, cause the terminal device 410 to perform operations and procedures relating to the UE device 110 as described above.

The network device 420 may be implemented as a single network node, or disaggregated/distributed over two or more network nodes, such as a central unit (CU), a distributed unit (DU), a remote radio head-end (RRH), using different functional-split architectures and different interfaces. The network device 420 may comprise one or more processors 421, one or more memories 422, one or more transceivers 423 and one or more network interfaces 427 interconnected through one or more buses 424. The one or more buses 424 may be address, data, or control buses, and may include any interconnection mechanism such as a series of lines on a motherboard or integrated circuit, copper cables, optical fibers, or other electrical/optical communication equipment, and the like. Each of the one or more transceivers 423 may comprise a receiver and a transmitter, which are connected to a plurality of antennas 426. The network device 420 may operate as a base station for the terminal device 410 and wirelessly communicate with the terminal device 410 through the plurality of antennas 426. The plurality of antennas 426 may form an antenna array to perform beamforming communication with the terminal device 410. The one or more network interfaces 427 may provide wired or wireless communication links through which the network device 420 may communicate with other network devices, entities or functions. The one or more memories 422 may include computer program code 425. The one or more memories 422 and the computer program code 425 may be configured to, when executed by the one or more processors 421, cause the network device 420 to perform operations and procedures relating to the base station (gNB) 120 as described above.

The one or more processors 411, 421 discussed above may be of any appropriate type that is suitable for the local technical network, and may include one or more of general purpose processors, special purpose processor, microprocessors, a digital signal processor (DSP), one or more processors in a processor based multi-core processor architecture, as well as dedicated processors such as those developed based on Field Programmable Gate Array (FPGA) and Application Specific Integrated Circuit (ASIC). The one or more processors 411, 421 may be configured to control other elements of the UE/network device and operate in cooperation with them to implement the procedures discussed above.

The one or more memories 412, 422 may include at least one storage medium in various forms, such as a volatile memory and/or a non-volatile memory. The volatile memory may include but not limited to for example a random access memory (RAM) or a cache. The non-volatile memory may include but not limited to for example a read only memory (ROM), a hard disk, a flash memory, and the like. Further, the one or more memories 412, 422 may include but not limited to an electric, a magnetic, an optical, an electromagnetic, an infrared, or a semiconductor system, apparatus, or device or any combination of above.

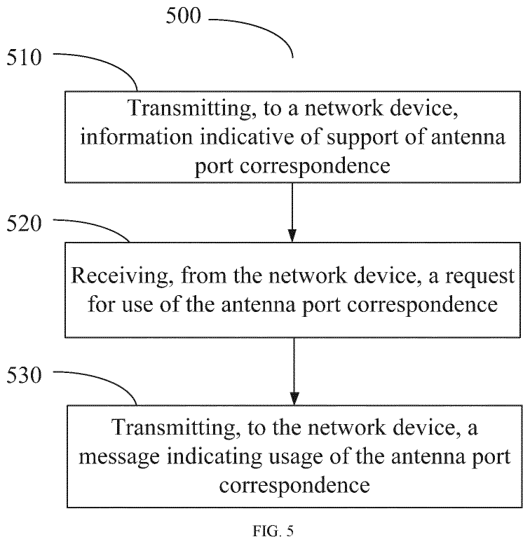

FIG. 5 shows a flow chart illustrating an example method 500 for correspondence between downlink reference signal and uplink reference signal according to an embodiment of the present disclosure. The example method 500 may be performed for example at a terminal device such as the UE device 110.

Referring to the FIG. 5, the example method 500 may include a step 510 of transmitting, to a network device, information indicative of support of antenna port correspondence between antenna ports used for reception of downlink (DL) reference signal (RS) resources and antenna ports used for transmission of uplink (UL) reference signal resources at the terminal device; a step 520 of receiving, from the network device, a request for use of the antenna port correspondence at the terminal device, and a step 530 of transmitting, to the network device, a message indicating usage of the antenna port correspondence at the terminal device.

Details of the step 510 have been described in above descriptions with respect to at least the operation 210, and repetitive descriptions thereof are omitted here.

Details of the step 520 have been described in above descriptions with respect to at least the operation 220, and repetitive descriptions thereof are omitted here.

Details of the step 530 have been described in above descriptions with respect to at least the operation 230, and repetitive descriptions thereof are omitted here.

In some embodiments, the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

In some embodiments, the antenna port correspondence indicates full correspondence in a case where the antenna ports used for reception of DL RS resources are the same antenna ports as being used for the transmission of UL RS resources at the terminal device.

In some embodiments, the antenna port correspondence indicates partial correspondence in a case where only a subset of the antenna ports used for the reception of DL RS resources are virtualized to corresponding antenna ports as being used for the transmission of UL RS resources at the terminal device.

In some embodiments, the antenna port correspondence is non-correspondence in a case where there is a fallback mode where the antenna port correspondence between DL RS and UL RS antenna ports is unknown at the terminal device.

In some embodiments, the at least one memory and the computer program code are further configured to, with the at least one processor, cause the terminal device to perform: signaling, to the network device, the antenna port correspondence semi-statically or dynamically.

In some embodiments, the at least one memory and the computer program code are further configured to, with the at least one processor, cause the terminal device to perform: determining the antenna port correspondence between UL and DL antenna ports associated with corresponding resources, before transmitting, to the network device, the antenna port correspondence.

In some embodiments, the at least one memory and the computer program code are further configured to, with the at least one processor, cause the terminal device to perform transitioning in the fallback mode in a case where there is non-correspondence between the antenna ports used for the reception of DL RS resources and the antenna ports used for the transmission of UL RS resources at the terminal device.

In some embodiments, the at least one memory and the computer program code are further configured to, with the at least one processor, cause the terminal device to perform continuing with maintenance of the antenna port correspondence for the next K slots in a case where there is the same level of correspondence between the antenna ports used for the reception of DL RS resources and the antenna ports used for the transmission of UL RS resources at the terminal device and the value of K is used as a timer indicative of validity of the antenna port correspondence.

In some embodiments, the at least one memory and the computer program code are further configured to, with the at least one processor, cause the terminal device to perform: sending, to the network device, a DL RS and UL RS antenna port virtualization suspend message in a case where the terminal device determines that the antenna port correspondence between the DL RS and UL RS is suspended at the terminal device.

In some embodiments, the at least one memory and the computer program code are further configured to, with the at least one processor, cause the terminal device to perform transitioning in the fallback mode in a case where the terminal device determines that the antenna correspondence is suspended at the terminal device.

In some embodiments, the downlink reference signal includes a demodulation reference signal, (DMRS) for data/control, or phase tracking reference signal (PTRS), or non-zero power channel state information reference signal (NZP-CSI-RS) for channel information acquisition or NZP-CSI-RS for frequency and time tracking or NZP-CSI-RS for beam management (BM).

In some embodiments, the uplink reference signal includes a sounding reference signal (SRS) or demodulation reference signal (DMRS) for data/control or phase tracking reference signal (PTRS) or preamble of physical random access channel (PRACH).

In some embodiments, the at least one memory and the computer program code are further configured to, with the at least one processor, cause the network device to perform: transmitting, to the network device, information on which associated antenna ports are selected by considering the antenna port correspondence or without considering the antenna port correspondence having correspondence and/or which antenna ports are having non-correspondence.

In some embodiments, the at least one memory and the computer program code are further configured to, with the at least one processor, cause the network device to perform: transmitting, to the network device an indication of power imbalance on the associated antenna ports selected between by considering the antenna port correspondence or without considering the antenna port correspondence at the terminal device.

In some embodiments, a metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

In some embodiments, the at least one memory and the computer program code are further configured to, with the at least one processor, cause the terminal device to perform: sending, to the network device, a DL RS and UL RS antenna port virtualization suspend message in a case where the terminal device detects that a current antenna port correspondence state is not maintainable.

In some embodiments, the maintainable current antenna port correspondence state indicates unexpected change in signal quality or due transmit transmission regulations.

In some embodiments, the fallback mode comprises a default antenna transmission mode where UL RS is virtualized into primary antenna port.

In some embodiments, the at least one memory and the computer program code are further configured to, with the at least one processor, cause the terminal device to switch into the fallback mode in a case where the terminal device receives, from the network device, a Layer1 or Layer2 control message to suspend the antenna port correspondence information.

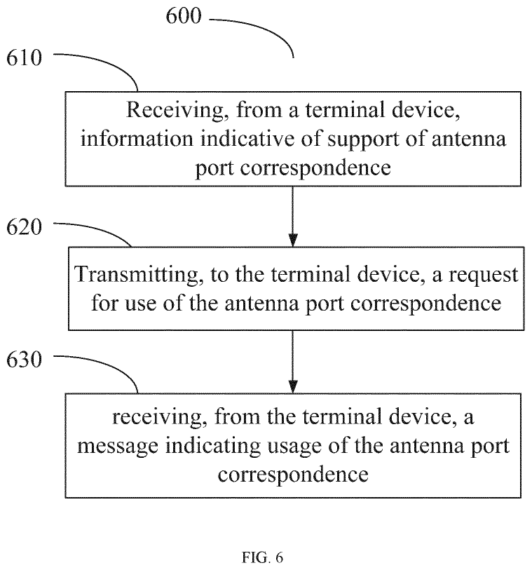

FIG. 6 shows a flow chart illustrating an example method 600 for correspondence between downlink reference signal and uplink reference signal according to an embodiment of the present disclosure. The example method 600 may be performed for example at a network device such as the base station 120.

Referring to the FIG. 6, the example method 600 may include a step 610 of receiving, from a terminal device, information indicative of support of antenna port correspondence between the antenna ports used for reception of downlink (DL) reference signal (RS) resources and antenna ports used for transmission of uplink (UL) reference signal resources at the terminal device; a step 620 of transmitting, to the terminal device, a request for use of the antenna port correspondence at the terminal device; and a step 630 of receiving, from the terminal device, a message indicating usage of the antenna port correspondence information at the terminal device. Details of the step 610 have been described in above descriptions with respect to at least the operation 210, and descriptions thereof are omitted here.

Details of the step 620 have been described in above descriptions with respect to at least the operation 220, and repetitive descriptions thereof are omitted here.

Details of the step 630 have been described in above descriptions with respect to at least the operation 230, and repetitive descriptions thereof are omitted here.

In some embodiments, the antenna port correspondence indicates full correspondence in a case where the antenna ports used for reception of DL RS resources are the same antenna ports as being used for the transmission of UL RS resources at the terminal device.

In some embodiments, the antenna port correspondence information indicates partial correspondence in a case where only a subset of the antenna ports used for the reception of DL RS resources are virtualized to corresponding antenna ports as being used for the transmission of UL RS resources at the terminal device.

In some embodiments, the antenna port correspondence is non-correspondence in a case where there is a fallback mode where the antenna port correspondence between DL RS and UL RS ports is unknown at the terminal device.

In some embodiments, the at least one memory and the computer program code are further configured to, with the at least one processor, cause the network device to perform transitioning in the fallback mode in a case where there is non-correspondence between the antenna ports used for the reception of DL RS resources and the antenna ports used for the transmission of UL RS resources at the terminal device.

In some embodiments, the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

In some embodiments, the at least one memory and the computer program code are further configured to, with the at least one processor, cause the network device to continue with maintenance of the antenna port correspondence and/or update the antenna port correspondence in a DL control message to the terminal device.

In some embodiments, the at least one memory and the computer program code are further configured to, with the at least one processor, cause the network device to perform transmitting, to the terminal device, a request for information on which antenna ports are having correspondence and/or which antenna ports are having non-correspondence.

In some embodiments, the at least one memory and the computer program code are further configured to, with the at least one processor, cause the network device to perform: transmitting, to the terminal device, a request for indication of power imbalance between correspondence and non-correspondence antenna ports at the terminal device.

In some embodiments, a metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

In some embodiments, the at least one memory and the computer program code are further configured to, with the at least one processor, cause the network device to perform continuing maintenance of the antenna port correspondence for the next K slot in a case where there is the same level of correspondence between antenna ports used for the reception of DL RS resources and antenna ports used for the transmission of UL RS resources at the terminal device, wherein the value of K is used as a timer to indicate validity of the antenna port correspondence.

In some embodiments, the at least one memory and the computer program code are further configured to, with the at least one processor, cause the network device to perform transitioning in the fallback mode in a case where the network device receives a DL RS and UL RS antenna port virtualization suspend message from the terminal device.

In some embodiments, the at least one memory and the computer program code are further configured to, with the at least one processor, cause the network device to perform transitioning in the fallback mode in a case where the network device detects that the antenna port correspondence between the DL RS and UL RS is suspended at the terminal device.

In some embodiments, the network device detects that the antenna port correspondence between the DL RS and UL RS is suspended in any of the following cases: the network receiving, from the terminal device, messages indicating non-correspondence between DL RS and UL RS antenna ports; the antenna port correspondence between the DL RS and UL RS being suspended by configuring DTX period; the antenna port correspondence between the DL RS and UL RS being suspended by configuring transmission mode in slot where DL&UL correspondence is not defined; and the antenna port correspondence between the DL RS and UL RS being suspended from reception measurements of discontinuity of UL&DL correspondence.

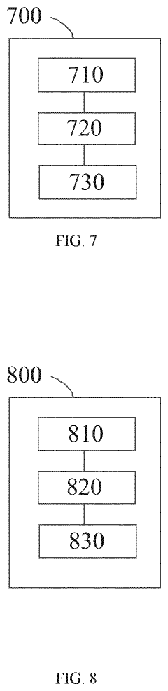

FIG. 7 shows a block diagram illustrating an example apparatus 700 for correspondence between downlink reference signals and uplink reference signals according to an embodiment of the present disclosure. Apparatus, for example, may be at least part of the UE device 110 in above examples.

As shown in FIG. 7, the example apparatus 700 may include means 710 for performing the step 510 of the example method 500, means 720 for performing the step 520 of the example method 500, means 730 for performing the step 530 of the example method 500. In one or more another example embodiment, at least one I/O interface, at least one antenna element, and the like may also be included in the example apparatus 700.

In some example embodiments, examples of means in the example apparatus 700 may include circuitries. For example, an example of means 710 may include a circuitry configured to perform the step 510 of the example method 500, an example of means 720 may include a circuitry configured to perform the step 520 of the example method 500, and an example of means 730 may include a circuitry configured to perform the step 530 of the example method 500 In some example embodiments, examples of means may also include software modules and any other suitable function entities.

FIG. 8 shows a block diagram illustrating an example apparatus 800 for correspondence between downlink reference signals and uplink reference signals according to an embodiment of the present disclosure. Apparatus, for example, may be at least part of the base station 120 in above examples.

As shown in the FIG. 8, the example apparatus 800 may include means 810 for performing the step 610 of the example method 600, means 820 for performing the step 620 of the example method 600, and means 830 for performing the step 630 of the example method 600. In one or more other example embodiments, at least one I/O interface, at least one antenna element, and the like may also be included in the example apparatus 800.

In some example embodiments, examples of means in the example apparatus 800 may include circuitries. For example, an example of means 810 may include a circuitry configured to perform the step 610 of the example method 600, an example of means 820 may include a circuitry configured to perform the step 620 of the example method 600, and an example of means 830 may include a circuitry configured to perform the step 630 of the example method 600. In some example embodiments, examples of means may also include software modules and any other suitable function entities.

Correspondence definition in this disclosure precludes beam width and beam direction related aspects. Antenna port virtualization definition in this disclosure refers to antenna elements which are allocated for each antenna port. In correspondence mode antenna elements being allocated into each antenna port are expected to be the same between downlink (DL) and uplink (UL).

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of some embodiments described above can be combined to provide further embodiments. Accompanying claims and their equivalents are intended to cover such forms or modifications as would fall within the scope and spirit of the disclosure.

Abbreviations used in the description and/or in the figures are defined as follows:
5G fifth generation
AP antenna port
BS base station
BW bandwidth
DMRS demodulation reference signal
gNB next generation NodeB/5G base station
PDSCH physical downlink shared channel
PRB physical resource block
RRC radio resource control
TB transport block
UE user equipment

1-72. (canceled)

73. A terminal device comprising:
at least one processor; and
at least one memory including computer program code, the at least one memory and the computer program code configured to, with the at least one processor, cause the terminal device to perform:
transmitting, to a network device, information indicative of support of antenna port correspondence between antenna ports used for reception of downlink (DL) reference signal (RS) resources and antenna ports used for transmission of uplink (UL) reference signal resources at the terminal device;
receiving, from the network device, a request for use of the antenna port correspondence at the terminal device; and
transmitting, to the network device, a message indicating usage of the antenna port correspondence at the terminal device.

74. The terminal device of claim 73, wherein the request comprises information on when to use the DL RS and UL RS antenna port correspondence at the terminal device, and/or the network device directly transmits the DL RS and UL RS antenna port correspondence information request if the network device has already received the information indicative of support of antenna port correspondence.

75. The terminal device of claim 73, wherein the antenna port correspondence indicates full correspondence in a case where the antenna ports used for reception of DL RS resources are the same antenna ports as being used for the transmission of UL RS resources at the terminal device.

76. The terminal device of claim 73, wherein the antenna port correspondence indicates partial correspondence in a case where only a subset of the antenna ports used for the reception of DL RS resources are virtualized to corresponding antenna ports as being used for the transmission of UL RS resources at the terminal device.

77. The terminal device of claim 76, wherein the at least one memory and the computer program code are further configured to, with the at least one processor, cause the network device to perform:
transmitting, to the network device, information on which associated antenna ports are selected by considering the antenna port correspondence or without considering the antenna port correspondence and/or by considering which antenna ports are having non-correspondence.

78. The terminal device of claim 77, wherein the at least one memory and the computer program code are further configured to, with the at least one processor, cause the network device to perform:
transmitting, to the network device an indication of power imbalance on the associated antenna ports by considering the antenna port correspondence or without considering the antenna port correspondence at the terminal device, wherein the metric for the indication of the power imbalance is based on at least one of: signal to interference plus noise ratio (SINR), reference signal received power (RSRP), reference signal received quality (RSRQ), received signal strength indicator (RSSI) of RS measurement from an antenna port, wherein the indication of the power imbalance is triggered when the measurement exceeds a threshold or imbalance is due to implementation loss, i.e. power offset, between antenna ports.

79. The terminal device of claim 73, wherein the antenna port correspondence is non-correspondence in a case where there is a fallback mode where the antenna port correspondence between DL RS and UL RS antenna ports is unknown at the terminal device.

80. The terminal device of claim 79, wherein the at least one memory and the computer program code are further configured to, with the at least one processor, cause the terminal device to perform transitioning in the fallback mode in a case where there is non-correspondence between the antenna ports used for the reception of DL RS resources and the antenna ports used for the transmission of UL RS resources at the terminal device.

81. The terminal device of claim 79, wherein the at least one memory and the computer program code are further configured to, with the at least one processor, cause the terminal device to perform transitioning in the fallback mode in a case where the terminal device determines that the antenna correspondence is suspended at the terminal device, wherein the fallback mode comprises a default antenna transmission mode where UL RS is virtualized into primary antenna port.

82. The terminal device of claim 79, wherein the at least one memory and the computer program code are further configured to, with the at least one processor, cause the terminal device to perform switching into the fallback mode in a case where the terminal device receives, from the network device, a Layer1 or Layer2 control message to suspend the antenna port correspondence information.

83. The terminal device of claim 73, wherein the at least one memory and the computer program code are further configured to, with the at least one processor, cause the terminal device to perform:
signaling, to the network device, the antenna port correspondence semi-statically or dynamically.

84. The terminal device of claim 73, wherein the at least one memory and the computer program code are further configured to, with the at least one processor, cause the terminal device to perform:
determining the antenna port correspondence between UL and DL antenna ports associated with corresponding resources, before transmitting, to the network device, the antenna port correspondence.

85. The terminal device of claim 73, wherein the at least one memory and the computer program code are further configured to, with the at least one processor, cause the terminal device to perform continuing with maintenance of the antenna port correspondence for the next K slots in a case where there is the same level of correspondence between the antenna ports used for the reception of DL RS resources and the antenna ports used for the transmission of UL RS resources at the terminal device and the value of K is used as a timer indicative of validity of the antenna port correspondence.

86. The terminal device of claim 85, wherein the at least one memory and the computer program code are further configured to, with the at least one processor, cause the terminal device to perform:
sending, to the network device, a DL RS and UL RS antenna port virtualization suspend message in a case where the terminal device detects that a current antenna port correspondence state is not maintainable.

87. The terminal device of claim 86, wherein the maintainable current antenna port correspondence state indicates unexpected change in signal quality or due transmit transmission regulations.

88. The terminal device of claim 85, wherein the at least one memory and the computer program code are further configured to, with the at least one processor, cause the terminal device to perform:
sending, to the network device, a DL RS and UL RS antenna port virtualization suspend message in a case where the terminal device determines that the antenna port correspondence between the DL RS and UL RS is suspended at the terminal device.

89. The terminal device of claim 73, wherein the DL RS resources comprise a demodulation reference signal, (DMRS) for data/control, or phase tracking reference signal (PTRS), or non-zero power channel state information reference signal (NZP-CSI-RS) for channel information acquisition or NZP-CSI-RS for frequency and time tracking or NZP-CSI-RS for beam management (BM).

90. The terminal device of claim 73, wherein the UL RS resources comprise includes a sounding reference signal (SRS) or demodulation reference signal (DMRS) for data/control or phase tracking reference signal (PTRS) or preamble of physical random access channel (PRACH).

91. A network device comprising:
at least one processor; and
at least one memory comprising computer program code, the at least one memory and the computer program code being configured to, with the at least one processor, cause the terminal device to perform:
receiving, from a terminal device, information indicative of support of antenna port correspondence between the antenna ports used for reception of downlink (DL) reference signal (RS) resources and antenna ports used for transmission of uplink (UL) reference signal resources at the terminal device;
transmitting, to the terminal device, a request for use of the antenna port correspondence at the terminal device; and
receiving, from the terminal device, a message indicating usage of the antenna port correspondence information at the terminal device.

92. A method implemented at a terminal device comprising:
transmitting, to a network device, information indicative of support of antenna port correspondence between antenna ports used for reception of downlink (DL) reference signal (RS) resources and antenna ports used for transmission of uplink (UL) reference signal resources at the terminal device;
receiving, from the network device, a request for use of the antenna port correspondence at the terminal device; and
transmitting, to the network device, a message indicating usage of the antenna port correspondence at the terminal device.
